(19) United States
(12) Patent Application Publication
(10) Pub. No.: US 2026/0125594 A1
(43) Pub. Date: May 7, 2026

(54) QUANTUM DOT-CONTAINING COMPOSITION AND METHOD FOR PRODUCING THE SAME

(71) Applicant: SHIN-ETSU CHEMICAL CO., LTD., Tokyo (JP)

(72) Inventors: Shinji AOKI, Annaka-shi (JP); Hitoshi MARUYAMA, Annaka-shi (JP); Yoshihiro NOJIMA, Annaka-shi (JP); Kazuya TOBISHIMA, Annaka-shi (JP)

(73) Assignee: SHIN-ETSU CHEMICAL CO., LTD., Tokyo (JP)

(21) Appl. No.: 19/118,372

(22) PCT Filed: Sep. 26, 2023
(86) PCT No.: PCT/JP2023/034817

§ 371 Date: Apr. 4, 2025

(30) Foreign Application Priority Data
Oct. 5, 2022 (JP) 2022-160770

(51) Int. Cl. C09K 11/62; C09K 113/00; G02B 5/22

(52) U.S. Cl. CPC C09K 11/623; G02B 5/22; C09K 2113/00

(57) ABSTRACT

A quantum dot-containing composition including quantum dots dispersed in a resin composition, the quantum dots emitting fluorescence by excitation light. The quantum dots include a ligand coordinated to the surface thereof and a surface coating layer bonded to the ligand and containing a siloxane bond, and the surface coating layer contains at least one of substituents of a polymer contained in the resin composition, substituents polymerizable with a polymer contained in the resin composition, and compounds having the same skeleton structure as the polymer. This provides a quantum dot-containing composition that has an enhanced stability and improved compatibility with highly polar solvents and photosensitive resin compositions while maintaining the properties of quantum dots, as well as a method for producing such a quantum dot-containing composition.

### TECHNICAL FIELD

The present invention relates to a quantum dot-containing composition and a method for producing the same.

### BACKGROUND ART

When the crystal size of semiconductor nanoparticle single crystals becomes smaller than or equal to the Bohr radius of excitons, a strong quantum confinement effect occurs, resulting in discrete energy levels discrete. This makes the energy levels dependent on the crystal size, allowing for adjusting the light absorption wavelength and the emission wavelength based on the crystal size. Additionally, the quantum confinement effect enhances the efficiency of light emission resulting from exciton recombination in the semiconductor nanoparticle single crystals, and this emission is basically characterized by emission lines. Thus, achieving a uniform particle size distribution would enable high-brightness, narrow-band emission. This is why semiconductor nanoparticle single crystals are gaining significant attention. The phenomenon caused by such a strong quantum confinement effect in nanoparticles is called the quantum size effect, and semiconductor nanoparticle single crystals that exploit this property, known as quantum dots, have been explored for their applications to a wide range of fields.

One application of quantum dots being explored is their use in a fluorescent material for displays. Achieving narrow-band and high-efficiency emission would enable the representation of colors that could not be reproduced with any existing technologies. This is why quantum dots are gaining attention as a next-generation display material.

Displays for which the use of quantum dots have been currently promoted include quantum dot liquid crystal displays, which are already being commercialized. Attempts have been made to convert white light or light emitted from a blue LED backlight to green or red by passing it through a quantum dot-containing wavelength conversion member. The surface of quantum dots is active, and the quantum yield gradually decreases due to moisture and oxygen in the atmosphere, so that enhancing the stability is an essential issue to consider for quantum dot-containing wavelength conversion members.

Various studies have been conducted on how to improve the stability of quantum dot-containing wavelength conversion members. One example approach is gas barrier sealing. This approach enhances the stability by forming an inner layer in which quantum dots are dispersed in an amphiphilic polymer or compatible polymer and by further dispersing quantum dots in another resin layer with low gas permeability. Patent Document 1 discloses a method of forming polymer beads by dispersing quantum dots (QDs) in a hydrophobic resin layer, modifying the surface of the polymer beads to allow them to be dispersed in a hydrophilic polymer, and dispersing them in the hydrophilic polymer. Hydrophilic polymers tend to have higher gas barrier properties than hydrophobic polymers, so that QDs are dispersed in such a bilayer or multilayer structure. However, the gas barrier properties are insufficient for use in applications where high temperatures and high humidity conditions are expected, such as in liquid crystal display units. Thus, a method is adopted in which the QD film is sandwiched between gas barrier films to remove the effects of oxygen and water vapor.

Various studies have also been conducted on how to fabricate polymer beads. Patent Document 2 discloses a method of fabricating QD-containing polymer beads from polysiloxane having an amino group and a polymerizable functional group and mixing them with a polymer having another polymerizable functional group to create an emulsion, followed by further curing it. This method uses a polymer incorporating ligands that coordinate to the surface of the QDs to enhance the adhesion to the QDs, which can increase the concentration of QDs contained in the polymer beads and thus enhance the stability. However, even with this method, the stability is still insufficient, and so the QD layer is sandwiched between barrier films for implementation.

Also Patent Document 3 discloses, which explores a method for improving heat and moisture resistance without using barrier films. In this method, silazane coating treatment is further applied to the multilayer resin composition incorporating the polymer beads structure disclosed in Patent Document 1, thereby enhancing the stability.

Patent Document 4 discloses still another approach. In this method, ligands coordinate to quantum dots, and reactive substituents such as vinyl and methacrylic groups introduced into the ligands. Then, a Si—H containing silicone resin and a curing agent are mixed, and the mixture is directly spin-coated and heat-cured to fabricate a film with improved heat and moisture resistance.

For application to color filters, it is important to create a quantum dot surface condition that is suitable for the patterning method used. Currently, photolithography methods are in practical use for fabrication of color filters. In these methods, a photosensitive resin composition containing pigments apply onto a glass substrate. After drying the solvent, the composition is UV-exposed through a mask, and uncured regions are removed by alkaline development to form a color pattern. The above process is repeated to form blue, red, and green patterns. The photolithography methods have many drawbacks, including significant material losses due to the waste of uncured regions, as well as complicated processes and the use of expensive equipment. For these reasons, the use of inkjet methods has also been explored in recent years. Inkjet methods eliminate material losses and allows for fabrication of large-size or large-area color filters without introducing expensive equipment, which makes the inkjet methods cost-competitive.

### CITATION LIST

### Patent Literature

Patent Document 1: U.S. Pat. No. 9,708,532 B2
Patent Document 2: JP 2016-111292 A
Patent Document 3: JP 2019-536653 A
Patent Document 4: US 2019/0322926 A1

### SUMMARY OF INVENTION

### Technical Problem

However, using barrier films as seen in Patent Documents 1 and 2 not only increases costs but also inevitably increase the thickness. Since thinner liquid crystal displays are currently required, wavelength conversion members need to be thinner, which leads to the need to enhance the stability without using barrier films. For application to color filters, patterning is required, and thus providing a protective layer such as a barrier film is not practical. As such, the stability of quantum dots themselves is required.

The method disclosed in Patent Document 3 has a drawback that the quantum yield decreases during photo-curing of the silazane coating with short-wavelength UV-irradiation (170 nm). In the method disclosed in Patent Document 4, there is low compatibility between using the Si—H-containing silicone resin and quantum dots, so that aggregation occurs when trying to disperse quantum dots at high concentrations. For this reason, ligand treatment is necessary to improve the compatibility. However, during ligand coordination, any change in balance between hydrophobic and hydrophilic groups increases the possibility of aggregation occurring, resulting in a decrease in quantum yield.

As regards inkjet methods, fabricating fine nozzles is technically difficult. Furthermore, a smaller nozzle size leads to problems such as clogging and unstable ejection. Thus, both photolithography methods, which have a proven track record, and inkjet methods, which are cost competitive, have been explored to achieve fine patterning. On the other hand, both photolithography and inkjet methods face the challenge of producing resin compositions that contain quantum dots at high concentrations in a highly dispersed state. Except for some types, resin compositions disperse in polar solvents such as PGMEA and PGME. Since quantum dots are basically hydrophobic, they are difficult to disperse in these solvents or resin materials and rather aggregate therein. As such, it is difficult to produce photosensitive resin compositions that contain quantum dots at high concentrations in a highly dispersed state. One countermeasure being explored is to add dispersants. However, this countermeasure has several drawbacks, including reducing the quantum dot content and altering the properties of the cured resin.

The present invention has been made in view of the above problems, and aims to provide a quantum dot-containing composition that has an enhanced stability and improved compatibility with highly polar solvents and photosensitive resin compositions while maintaining the properties of quantum dots, as well as a method for producing such a quantum dot-containing composition.

### Solution to Problem

To solve the above problems, the present invention provides a quantum dot-containing composition including quantum dots dispersed in a resin composition, the quantum dots emitting fluorescence by excitation light, wherein the quantum dots include a ligand coordinated to a surface thereof and a surface coating layer bonded to the ligand and containing a siloxane bond, and the surface coating layer contains at least one of substituents of a polymer contained in the resin composition, substituents polymerizable with a polymer contained in the resin composition, and compounds having a same skeleton structure as the polymer.

Such a quantum dot-containing composition can be a quantum dot-containing composition that has an enhanced stability and improved compatibility with highly polar solvents and photosensitive resin compositions while maintaining the properties of quantum dots.

In the present invention, the quantum dots preferably contain a quantum dot core selected from the group consisting of II-VI, III-V, IV, IV-VI, I-III-VI and II-IV-V groups, mixed crystals and alloys thereof, and compounds having a perovskite structure.

Such quantum dots can emit fluorescence by excitation light.

In this time, the quantum dots preferably contain a core-shell quantum dot having the quantum dot core coated with a shell with a larger band gap than the quantum dot core.

Such quantum dots emit light in a stable manner, making them relatively easier to handle.

In the present invention, the ligand preferably includes one or more of an amino group, a thiol group, a carboxy group, a phosphino group, a phosphine oxide group, and an ammonium ion.

Such a ligand is preferable as it readily coordinates to the quantum dot surface.

In the present invention, the substituents of a polymer contained in the resin composition are preferably one or more of a vinyl group, an acrylic group, a methacrylic group, a hydroxy group, a phenolic hydroxy group, and an epoxy group.

Such substituents do not alter the surface structure of the quantum dots and can mix under mild conditions.

In the present invention, the substituents polymerizable with a polymer contained in the resin composition are preferably one or more of a vinyl group, an acrylic group, a methacrylic group, a hydroxy group, a phenolic hydroxy group, and an epoxy group.

Such substituents improve compatibility with the resin composition and can mix under mild conditions. Additionally, such substituents enable polymerization between the resin composition and the quantum dots during curing, thereby immobilizing the quantum dots within the resin composition and thus suppressing aggregation.

In the present invention, the same skeleton structure as the polymer is preferably a skeleton structure derived from acrylic acid, methacrylic acid, acrylic acid esters or methacrylic acid esters, a silphenylene skeleton, a norbornene skeleton, a fluorene skeleton, or an isocyanurate skeleton.

Such a skeleton structure improves compatibility with the polymer.

The present invention also provides a wavelength conversion member including a cured product of the quantum dot-containing composition.

Such a wavelength conversion member suppresses the degradation of fluorescence emission efficiency under high-temperature and high-humidity conditions, providing high reliability.

The present invention also provides a method for producing the aforementioned quantum dot-containing composition containing quantum dots that emit fluorescence by excitation light, the method includes:
a ligand exchange step of mixing a solution in which the quantum dots are dispersed with a ligand having a siloxane bond-forming substituent to thereby coordinate the ligand to an outermost surface of the quantum dots;
a surface coating layer formation step of initiating, after the ligand exchange step, a reaction between the siloxane bond-forming substituent and a compound that reacts with the siloxane bond-forming substituent to generate polysiloxane, to thereby form a surface coating layer; and
a resin composition mixing step of mixing, after the surface coating layer formation step, the quantum dots coated with the surface coating layer with the resin composition.

Such a method for producing a quantum dot-containing composition can produce a quantum dot-containing composition that has an enhanced stability and improved compatibility with highly polar solvents and photosensitive resin compositions while maintaining the properties of quantum dots.

### Advantageous Effects of Invention

As described above, the inventive quantum dot-containing composition can provide a quantum dot-containing composition that has an enhanced stability and improved compatibility with highly polar solvents and photosensitive resin compositions while maintaining the properties of quantum dots.

### DESCRIPTION OF EMBODIMENTS

As described above, it has been desired to develop a quantum dot-containing composition that has an enhanced stability and improved compatibility with highly polar solvents and photosensitive resin compositions while maintaining the properties of quantum dots, and a method for producing the quantum dot-containing composition.

The present inventors have earnestly studied to achieve the above object and consequently found that the stability can be enhanced by forming a siloxane-containing surface coating layer for passivation. Furthermore, the compatibility with a resin composition can be improved by introducing, into the surface coating layer, a compound with the same skeleton structure as the monomer or polymer in the resin composition. Furthermore, quantum dots that can be cured even when added in high concentrations can be produced by introducing a substituent that is polymerizable with a polymer in the resin composition, and the compatibility can be improved by introducing a substituent that the polymer in the resin composition possesses. As a result, the present inventors have found that the stabilization is possible without using barrier films, as the decrease rate of internal quantum efficiency in a reliability test conducted at 85° C. and 85% RH could be limited to within 10% after 250 hours of treatment. Additionally, the compatibility with the resin composition can be improved, making it possible to realize a uniformly disperse state with no aggregates observed.

That is, the present invention is a quantum dot-containing composition including quantum dots dispersed in a resin composition, the quantum dots emitting fluorescence by excitation light, wherein the quantum dots include a ligand coordinated to a surface thereof and a surface coating layer bonded to the ligand and containing a siloxane bond, and the surface coating layer contains at least one of substituents of a polymer contained in the resin composition, substituents polymerizable with a polymer contained in the resin composition, and compounds having a same skeleton structure as the polymer.

Hereinafter, the present invention will be described in detail. However, the present invention is not limited to the following description.

The inventive quantum dot-containing composition is a quantum dot-containing composition including quantum dots dispersed in a resin composition. The quantum dot-containing composition includes a ligand coordinated to the surface of the quantum dots and a surface coating layer bonded to the ligand and containing a siloxane bond.

### (Quantum Dots)

The quantum dots used in the present invention are not limited as long as they emit fluorescence by excitation light, and any form of quantum dots can be used. While quantum dots are primarily nanoparticles of 10 nm or smaller, any other shapes are also applicable, such as nanowires, nanorods, nanotubes, and nanocubes.

The quantum dots used in the present invention can contain a quantum dot core made of any suitable material, which is, e.g., a semiconductor material selected from the group consisting of II-VI, III-V, IV, IV-VI, I-III-VI and II-IV-V groups, mixed crystals and alloys thereof, and compounds having a perovskite structure.

Specific examples include, but are not limited to, compounds including ZnS, ZnSe, ZnTe, CdS, CdSe, CdTe, AlN, AlP, AlAs, AlSb, GaN, GaP, GaAs, GaSb, InN, InP, InAs, InSb, Si, Ge, Sn, Pb, PbS, PbSe, PbTe, SnS, SnSe, SnTe, AgGaS₂, AgInS₂, AgGaSe₂, AgInSe₂, CuGaS₂, CuGaSe₂, CuInS₂, CuInSe₂, ZnSiP₂, ZnGeP₂, CdSiP₂, CdGeP₂, CsPbCl₃, CsPbBr₃, CsPbI₃, CsSnCl₃, CsSnBr₃, and CsSnI₃.

In addition, the quantum dots used in the present invention can have a core-shell structure. Shell materials that can form a core-shell structure are preferably, but not limited to, those with a large band gap and low lattice mismatch relative to the core material, and they can be combined in any way to suit the core material. Specific example shell materials include, but are not limited to, ZnO, ZnS, ZnSe, ZnTe, CdS, CdSe, CdTe, AlN, AlP, AlAs, AlSb, GaN, GaP, GaAs, GaSb, InN, InP, InAs, InSb, BeS, BeSe, BeTe, MgS, MgSe, MgTe, PbS, PbSe, PbTe, SnS, SnSe, SnTe, CuF, CuCl, CuBr, and CuI, where these materials may be selected alone or as mixed crystals of multiple compounds.

The quantum dots preferably contain a core-shell quantum dot having the quantum dot core coated with a shell with a larger band gap than the quantum dot core.

There are various methods for producing quantum dots, including liquid-phase and vapor-phase methods. While the present invention is not limited to using any particular method, from the perspective of achieving high fluorescence emission efficiency, it is preferable to use semiconductor nanoparticles that are obtained using a hot soap method or a hot injection method, in which precursor species undergo reactions at high temperatures in a high-boiling-point nonpolar solvent. It is desirable for the nanoparticles to have an organic ligand coordinated to their surface to impart dispersibility in non-polar solvents and reduce surface defects.

From the perspective of dispersibility, the organic ligand preferably contains aliphatic hydrocarbons. Examples of such an organic ligand include oleic acid, stearic acid, palmitic acid, myristic acid, lauric acid, decanoic acid, octanoic acid, oleylamine, stearyl (octadecyl)amine, dodecyl (lauryl)amine, decylamine, octylamine, octadecanethiol, hexadecanethiol, tetradecanethiol, dodecanethiol, decanethiol, octanethiol, trioctylphosphine, trioctylphosphine oxide, triphenylphosphine, triphenylphosphine oxide, tributylphosphine, and tributylphosphine oxide. These may be used alone or in mixtures thereof.

### (Ligands Coordinated to Quantum Dots)

The quantum dots of the present invention have ligands that are coordinated to their surface. It is desirable for a ligand with substituents that can form a siloxane bond to be coordinated to the quantum dots in the present invention, in addition to the aforementioned organic ligand. It is desirable for the ligand with substituents that can form a siloxane bond to have substituents that interact with or adsorb to the quantum dot surface. Examples of substituents that interact with or adsorb to the quantum dot surface include amino groups, thiol groups, carboxy groups, mercapto groups, phosphino groups, phosphine groups, phosphine oxide groups, sulfonyl groups, ammonium ions, and quaternary ammonium salts. Among these, amino groups, carboxy groups, mercapto groups, phosphine groups, and quaternary ammonium salts are preferred in terms of their strong coordinating properties.

It is desirable for the inventive quantum dot-containing composition to have the surface of the quantum dots coated with a polymer using polysiloxane. Therefore, it is desirable for the ligand with substituents that can be coordinated to the surface of the quantum dots to have substituents that can form a siloxane bond. Examples of substituents that can form a siloxane bond include compounds containing alkoxysilanes such as trimethoxysilyl groups, triethoxysilyl groups, dimethoxymethylsilyl groups, diethoxymethylsilyl groups, dimethylmethoxysilyl groups, and ethoxydimethylsilyl groups, compounds with a silazane bond, compounds with a Si—OH bond, compounds with a Si—X (X: halogen) bond, and carboxylic acids. Among these, ligands containing alkoxysilane, silazane, or a Si—OH group are preferred as they allow the reaction to proceed under mild conditions without generating acid as reaction byproducts.

### (Surface Coating Layer)

The inventive quantum dot-containing composition has a surface coating layer that is bonded to the aforementioned ligand with substituents that can form a siloxane bond and contains the siloxane bond. It is desirable for the inventive quantum dot-containing composition to have the quantum dot surface coated with a polymer using polysiloxane. Therefore, it is desirable to form a quantum dot surface coating layer containing polysiloxane, by means of a reaction with the substituents that can form a siloxane bond, which are contained in the aforementioned ligand with substituents that can be coordinated to the quantum dots.

The inventive surface coating layer contains at least one of substituents of a polymer contained in the resin composition (described below), substituents polymerizable with a polymer contained in the resin composition (described below), and compounds having the same skeleton structure as the polymer. It is desirable for the substituents of the polymer, the substituents polymerizable with the polymer, or the compounds having the same skeleton structure to be contained in the surface coating layer through the formation of a covalent bond. If these substituents or compounds are contained in the surface coating layer in such a way as to be associated with the surface-coated quantum dots or coordinated to the quantum dot surface or surface coating layer, they may easily detach during subsequent purification treatment, preventing them from exhibiting the desired properties.

Examples of substituents polymerizable with the polymer include vinyl groups, acrylic groups, methacrylic groups, hydroxy groups, phenolic hydroxy groups, epoxy groups, sulfonyl groups, carboxy groups, and thiol groups. However, introducing strongly acidic substituents or those that are easily coordinated to the quantum dots may often lead to aggregation. Therefore, vinyl groups, acryl groups, methacryl groups, hydroxy groups, phenolic hydroxy groups, and epoxy groups are preferred.

Compounds with the same skeleton structure as the polymer contained in the resin composition include those with a skeleton structure derived from acrylic acid, methacrylic acid, acrylic acid esters or methacrylic acid esters, a silphenylene skeleton, a norbornene skeleton, a fluorene skeleton, or an isocyanurate skeleton. The type, number, and ratio of compounds to be introduced may be appropriately adjusted to prevent aggregation or the like from occurring when mixing the resin composition with quantum dots.

### (Resin Composition)

The inventive quantum dot-containing composition is a mixture of quantum dots and a resin composition. The resin composition may contain not only a polymer as a base polymer but also a polymerization initiator, and may also contain an organic solvent, a polymerizable cross-linking agent, a photoacid generator, an antioxidant, a light scattering agent, etc. Suitable polymers include polymers derived from acrylic acid, methacrylic acid, acrylic acid esters, or methacrylic acid esters as well as copolymers combining some of these monomers, polymers containing glycidyl (meth)acrylate in the repeating unit, and polymers with a siloxane, urethane, silphenylene, norbornene, fluorene, or isocyanurate skeleton. Any polymer may be selected to suit the intended application. Examples include acrylic resins, alkyd resins, melamine resins, epoxy resins, silicone resins, polyvinyl alcohols, polyvinylpyrrolidones, polyimide precursors such as polyamides, polyamide-imides, and polyimides and their esterification products, and reaction products of tetracarboxylic dianhydrides and diamines. In addition, polymerizable substituents are introduced into these polymers, so that they can be cured by being combined with a polymerization initiator. Radical polymerizable substituents include vinyl groups, acrylic groups, methacrylic groups, and thiol groups, all of which can be suitably used. Cationic polymerizable substituents include hydroxy groups, phenolic hydroxy groups, epoxy groups, glycidyl groups, oxetanyl groups, and isocyanate groups, all of which can be suitably used. Additionally, carboxyl groups may be introduced to impart alkali developability.

### (Polymerization Initiator)

Preferably, the inventive quantum dot-containing composition also contains a polymerization initiator. Polymerization initiators include thermal initiators and photoinitiators, both of which can be suitably used depending on the base polymer. Radical photoinitiators include Irgacure® series commercially available from BASF, including, for example, Irgacure 290, Irgacure 651, Irgacure 754, Irgacure 184, Irgacure 2959, Irgacure 907, Irgacure 369, Irgacure 379, Irgacure 819, and Irgacure 1173. Another example is Darocure® series, including, for example, TPO and Darocure 1173. Alternatively, the inventive quantum dot-containing composition may contain a known radical thermal initiator or cationic photoinitiator,

The polymerization initiator content is preferably 0.1 to 10 parts by mass, more preferably 0.2 to 5 parts by mass, per 100 parts by mass of the polymer to be added.

### (Solvent)

The inventive quantum dot-containing composition may contain a solvent to improve its coatability. In terms of compatibility with quantum dots, the solvent is preferably an organic solvent, examples of which include ketones, alkylene glycol ethers, alcohols, and aromatic compounds. From the ketone group, acetone, methyl ethyl ketone, cyclohexanone, etc. can be suitably used. From the alkylene glycol ether group, methyl cellosolve (ethylene glycol monomethyl ether), butyl cellosolve (ethylene glycol monobutyl ether), methyl cellosolve acetate, ethyl cellosolve acetate, butyl cellosolve acetate, ethylene glycol monopropyl ether, ethylene glycol monohexyl ether, ethylene glycol dimethyl ether, diethylene glycol ethyl ether, diethylene glycol diethyl ether, propylene glycol monomethyl ether, propylene glycol monoethyl ether, propylene glycol monopropyl ether, propylene glycol monobutyl ether, propylene glycol monomethyl ether acetate, diethylene glycol methyl ether acetate, diethylene glycol ethyl ether acetate, diethylene glycol propyl ether acetate, diethylene glycol isopropyl ether acetate, diethylene glycol butyl ether acetate, diethylene glycol tertiary butyl ether acetate, triethylene glycol methyl ether acetate, triethylene glycol ethyl ether acetate, triethylene glycol propyl ether acetate, triethylene glycol isopropyl ether acetate, triethylene glycol butyl ether acetate, triethylene glycol tertiary butyl ether acetate, etc. can be suitably used. From the alcohol group, methyl alcohol, ethyl alcohol, isopropyl alcohol, n-butyl alcohol, 3-methyl-3-methoxybutanol, etc. can be suitably used. From the aromatic solvent group, benzene, toluene, and xylene can be suitably used.

The inventive quantum dot-containing composition may also contain a polymerizable cross-linking agent, a photoacid generator, an antioxidant, a light scattering agent, etc., which can be adjusted appropriately based on the polymerizability and coatability.

### (Wavelength Conversion Member)

The inventive wavelength conversion member is a cured product of the quantum dot-containing composition. Example forms of the inventive wavelength conversion member include, but are not limited to, a wavelength conversion film obtained by processing the composition into a sheet and then curing it so that quantum dots are dispersed within the resin, and a wavelength conversion color filter patterned using an inkjet technique or a resist material. The method for producing the wavelength conversion material is not limited. For example, the wavelength conversion material can be obtained by coating a transparent film such as PET and polyimide or a substrate material with the quantum dot-containing composition and then curing the composition to laminate the film or substrate.

For coating onto the transparent film, spraying methods such as spraying and inkjet, as well as spin coating and a bar coater can be used.

The method for curing the quantum dot-containing composition is not limited. For example, the curing can be done by heating the film coated with the quantum dot-containing composition at 60° C. for 2 hours, followed by heating at 150° C. for 4 hours. Alternatively, photopolymerization reactions can be used to cure the quantum dot-containing composition. The curing method can change appropriately to suit the intended application.

Introducing the substituents polymerizable with the polymer in the resin composition into such a surface coating layer makes it possible to produce a wavelength conversion member with high reliability after curing, without aggregation or curing inhibition.

### (Method for Producing a Quantum Dot-Containing Composition)

The present invention provides a method for producing the aforementioned quantum dot-containing composition containing quantum dots that emit fluorescence by excitation light, the method including:
a ligand exchange step of mixing a solution in which the quantum dots are dispersed with a ligand having a siloxane bond-forming substituent to thereby coordinate the ligand to an outermost surface of the quantum dots;
a surface coating layer formation step of initiating, after the ligand exchange step, a reaction between the siloxane bond-forming substituent and a compound that reacts with the siloxane bond-forming substituent to generate polysiloxane, to thereby form a surface coating layer; and
a resin composition mixing step of mixing, after the surface coating layer formation step, the quantum dots coated with the surface coating layer with the resin composition.

For example, the inventive quantum dot-containing composition can be produced by the following method.

First, quantum dots coordinated with a ligand containing long-chain hydrocarbons disperse in a hydrophobic solvent. Then, the solution mixes with a ligand having a siloxane bond-forming substituent and a substituent that coordinates to the quantum dot surface to initiate a ligand exchange reaction. The conditions for the ligand exchange reaction, including the amount of ligand added, heating temperature, reaction time, and light irradiation, are adjusted appropriately depending on the type of ligand.

Then, the siloxane bond-forming substituent is caused to react with a compound that reacts with the siloxane bond-forming substituent to generate polysiloxane, to thereby initiate a polysiloxane-forming reaction with the quantum dots coordinated with the ligand containing the substituent capable of forming a siloxane bond, resulting in the formation of a surface coating layer containing the siloxane bond.

Then, the quantum dots coated with the surface coating layer mixes with the resin composition to produce the quantum dot-containing composition.

Sol-gel methods are generally suitably used for forming the polysiloxane bond. However, since quantum dots are sensitive to acidic conditions and moisture, it is preferable to use a sol-gel method under basic conditions, and more preferable to use a non-hydrolytic sol-gel method using diphenylsilanediol, tetramethyldisiloxanediol, or the like. The surface coating layer in the present invention contains at least one of substituents of a polymer contained in the resin composition, substituents polymerizable with the polymer contained in the resin composition, and compounds having the same skeleton structure as the polymer contained in the resin composition. It is desirable for the substituents polymerizable with the polymer contained in the resin composition or the compounds having the same skeleton structure to be contained in the surface coating layer through the formation of a covalent bond. The method for forming the covalent bond is not limited. For example, a suitable method involves introducing a substituent that can form a siloxane bond into a substituent polymerizable with the polymer contained in the resin composition or a compound having the same skeleton structure as the polymer contained in the resin composition and adding this substituent or compound during the aforementioned non-hydrolytic sol-gel reaction, thereby allowing it to be contained in the surface coating layer while forming a covalent bond. Another suitable method involves introducing a substituent polymerizable with the polymer contained in the resin composition during the aforementioned non-hydrolytic sol-gel reaction, followed by causing it to react with a polymer or monomer to introduce it into the surface coating layer. After forming the surface coating layer, unreacted substances are removed by purification, and then the quantum dots can be mixed with the resin composition to produce a quantum dot-containing composition. Forming the surface coating layer enhances compatibility with the resin composition, making it possible to produce a quantum dot-containing composition in which quantum dots are uniformly dispersed without aggregation.

### EXAMPLES

The present invention is now further detailed with reference to Examples and Comparative Examples, though the present invention is not limited to these examples. In Examples, InP/ZnSe/ZnS core-shell quantum dots were used as the quantum dot material.

### Example 1

### (Quantum Dot Core Synthesis Step)

To a flask were added 0.23 g (0.9 mmol) of palmitic acid, 0.088 g (0.3 mmol) of indium acetate, and 10 mL of 1-octadecene. The mixture was heated with stirring at 100° C. under reduced pressure, and then degassed for 1 hour while dissolving the raw materials. Thereafter, nitrogen was purged into the flask, and 0.75 mL (0.15 mmol) of 0.2 M solution prepared by mixing tristrimethylsilylphosphine with trioctylphosphine was added, followed by raising the temperature to 300° C., and it was confirmed that the solution changed from yellow to red and the core particles were formed.

### (Quantum Dot Shell Layer Synthesis Step)

Then, 2.85 g (4.5 mmol) of zinc stearate and 15 mL of 1-octadecene were added to another flask. The mixture was heated with stirring at 100° C. under reduced pressure, and then degassed for 1 hour while being dissolved to prepare a 0.3 M solution of octadecene zinc stearate. Then, 3.0 mL (0.9 mmol) of this solution was added to the reaction solution after the core synthesis, followed by cooling the reaction solution to 200° C. Next, 0.474 g (6 mmol) of selenium and 4 mL of trioctylphosphine were added to another flask and dissolved by heating to 150° C. to prepare a 1.5 M solution of selenium trioctylphosphine. While raising the temperature of the reaction solution after the core synthesis step, which had been cooled to 200° C., to 320° C. over 30 minutes, a total of 0.6 mL (0.9 mmol) of the selenium trioctylphosphine solution was added, in 0.1 mL steps, to the reaction solution, which was then held at 320° C. for 10 minutes and cooled to room temperature. To this solution, 0.44 g (2.2 mmol) of zinc acetate was added and dissolved by heating with stirring at 100° C. under reduced pressure. The flask was purged again with nitrogen, and the temperature was raised to 230° C., followed by adding 0.98 mL (4.0 mmol) of 1-dodecanethiol and holding the solution for 1 hour. The resulting solution was cooled to room temperature to prepare a solution containing core-shell quantum dots.

### (Ligand Exchange Step)

As a ligand having a substituent that can form a siloxane bond and a substituent that coordinates to the quantum dot surface, (3-mercaptopropyl)triethoxysilane (available from Tokyo Chemical Industry Co., Ltd.) was used. For the ligand exchange reaction, (3-mercaptopropyl)triethoxysilane (3.0 mmol) was added to the solution after the shell layer synthesis step, which had been cooled to room temperature, followed by string the solution for 24 hours. After completion of the reaction, ethanol was added to precipitate the reaction solution, which was then centrifuged to remove the supernatant. A similar purification was performed again, followed by dispersing the solution in toluene to obtain a quantum dot solution coordinated with the ligand having a substituent that can form a siloxane bond.

### (Surface Coating Layer Formation Step)

To a nitrogen-purged flask were added triethoxyvinylsilane (4.0 mmol), diphenylsilanediol (6.0 mmol), barium hydroxide monohydrate (0.15 mmol), and the quantum dot toluene solution after the ligand exchange step, followed by heating with stirring at 65° C. for 24 hours. After completion of the reaction, the solution was cooled to room temperature, and ethanol was added to precipitate the reaction solution, which was then centrifuged to remove the supernatant. The solution was then dispersed in toluene and added to a nitrogen-purged flask. Then, 2 parts by mass of methacrylate-modified silicone oil X-32-3817-3 (available from Shin-Etsu Chemical Co., Ltd.) was added per 100 parts by mass of the quantum dot toluene solution. After stirring, mixing, and defoaming, the solution was irradiated with light from a UV-LED irradiation device (wavelength: 365 nm, output: 4000 mW/cm²) for 20 seconds while being stirred. After completion of the reaction, ethanol was added to precipitate the solution, which was then centrifuged to remove the supernatant. The solution was then dispersed in toluene again.

### (Resin Composition Mixing Step)

The solution after the surface coating layer formation step, dispersed in toluene, and methacrylate-modified silicone oil X-32-3817-3 (available from Shin-Etsu Chemical Co., Ltd.) were weighed and mixed to contain 20% by mass of quantum dots in terms of the ratio of nonvolatile components. After mixing, 1 part by mass of a thermal radical initiator AIBN (available from Tokyo Chemical Industry Co., Ltd.) was added per 100 parts by mass of the methacrylate-modified silicone oil to obtain a quantum dot-containing composition.

### (Method for Producing a Wavelength Conversion Member)

A wavelength conversion member was fabricated using the obtained quantum dot-containing composition. The quantum dot-containing composition was vacuum degassed and, after adjusting its solid content concentration to 20%, poured into a fluororesin-coated, 20 cm×10 cm, 500 μm thick mold. The composition was then heated on a hot plate at 120° C. for 1 hour to thermally cure the quantum dot-containing composition while volatilizing the solvent. The composition was then removed from the mold. Thus, a 100 μm thick wavelength conversion member was fabricated.

### (Measurement of Emission Wavelength, Emission Half-Width, and Emission Efficiency)

For evaluation of fluorescence emission properties of the quantum dot-containing composition in each of Examples and Comparative Examples, a quantum efficiency measurement system QE-2100 (available from Otsuka Electronics Co., Ltd.) was used to measure the emission wavelength, fluorescence emission half width, and fluorescence emission efficiency (internal quantum efficiency) of the quantum dots at an excitation wavelength of 450 nm.

### (Reliability Test)

The obtained wavelength conversion member was treated for 250 hours under conditions of 85° C. and 85% RH (relative humidity), and the fluorescence emission efficiency of the treated wavelength conversion member was measured to evaluate the reliability.

### Comparative Example 1

The same steps as those in Example 1 were followed up to the quantum dot shell layer synthesis step, and then the resin composition mixing step was carried out without the ligand exchange step and the surface coating layer formation step. Methacrylate-modified silicone oil X-32-3817-3 (available from Shin-Etsu Chemical Co., Ltd.) was weighed and mixed to the solution after the quantum dot shell layer synthesis step to contain 20% by mass of quantum dots in terms of the ratio of nonvolatile components. After mixing, the solvent was removed, and 1 part by mass of a thermal radical initiator AIBN (available from Tokyo Chemical Industry Co., Ltd.) was added per 100 parts by mass of the added methacrylate-modified silicone oil to obtain a quantum dot-containing composition. Except for the above conditions, a wavelength conversion member was fabricated in the same manner as in Example 1.

### Example 2

The same steps as those in Example 1 were followed up to the ligand exchange step.

### (Surface Coating Layer Formation Step)

To a nitrogen-purged flask were added triethoxysilylpropyl methacrylate (4.0 mmol), diphenylsilanediol (6.0 mmol), barium hydroxide monohydrate (0.15 mmol), and the quantum dot toluene solution after the ligand exchange step, followed by heating with stirring at 65° C. for 24 hours. After completion of the reaction, the solution was cooled to room temperature, and ethanol was added to precipitate the reaction solution, which was then centrifuged to remove the supernatant. The solution was then dispersed in toluene and added to a nitrogen-purged flask. Then, 2 parts by mass of acrylic resin RA-4101 (available from Negami Chemical Industrial Co., Ltd) was added per 100 parts by mass of the quantum dot toluene solution. Further, 1 part by mass of Irgacure 1173 was added per 100 parts by mass of the acrylic resin. After stirring and mixing, the solution was irradiated with light from a UV-LED irradiation device (wavelength: 365 nm, output: 4000 mW/cm²) for 20 seconds. After completion of the reaction, ethanol was added to precipitate the solution, which was then centrifuged to remove the supernatant. The solution was then dispersed in toluene again.

### (Resin Composition Mixing Step)

The solution after the surface coating layer formation step, dispersed in toluene, and acrylic resin RA-4101 (available from Negami Chemical Industrial Co., Ltd) were weighed to contain 20% by mass of quantum dots in terms of the ratio of nonvolatile components. Then, 1 part by mass of a thermal radical initiator AIBN (available from Tokyo Chemical Industry Co., Ltd.) was added and mixed per 100 parts by mass of the nonvolatile component of the acrylic resin. After mixing, the toluene solvent was removed by vacuum distillation to obtain a quantum dot-containing composition.

### (Method for Producing a Wavelength Conversion Member)

A wavelength conversion member was fabricated using the obtained quantum dot-containing composition. The quantum dot-containing composition was vacuum degassed and, after adjusting its solid content concentration to 20%, poured into a fluororesin-coated, 20 cm×10 cm, 500 μm thick mold. The composition was then heated on a hot plate at 120° C. for 1 hour to thermally cure the quantum dot-containing composition while volatilizing the solvent. The composition was then removed from the mold. Thus, a 100 μm thick wavelength conversion member was fabricated.

### Comparative Example 2

The same steps as those in Example 1 were followed up to the quantum dot shell layer synthesis step, and a wavelength conversion member was fabricated in the same manner as in Example 2 without the ligand exchange step and the surface coating layer formation step.

### Example 3

The same steps as those in Example 1 were followed up to the ligand exchange step.

### (Surface Coating Layer Formation Step)

To a nitrogen-purged flask were added triethoxysilylpropyl methacrylate (4.0 mmol), diphenylsilanediol (6.0 mmol), barium hydroxide monohydrate (0.15 mmol), and the quantum dot toluene solution after the ligand exchange step, followed by heating with stirring at 65° C. for 24 hours. After completion of the reaction, the solution was cooled to room temperature, and ethanol was added to precipitate the reaction solution, which was then centrifuged to remove the supernatant. The solution was then dispersed in toluene and added to a nitrogen-purged flask. Then, 2 parts by mass of an isocyanuric acid derivative DA-MGIC (available from Shikoku Chemicals Corporation) was added per 100 parts by mass of the quantum dot toluene solution. Further, 1 part by mass of Irgacure 1173 was added per 100 parts by mass of DA-MGIC. After stirring and mixing, the solution was irradiated with light from a UV-LED irradiation device (wavelength: 365 nm, output: 4000 mW/cm²) for 20 seconds. After completion of the reaction, ethanol was added to precipitate the solution, which was then centrifuged to remove the supernatant. The solution was then dispersed in toluene again.

### (Resin Composition Mixing Step)

Epoxy-containing silicone resin (CAS No. 2253674-54-1; available from Shin-Etsu Chemical Co., Ltd.) and the solution after the surface coating layer formation step, dispersed in toluene, were weighed and mixed to contain 20% by mass of quantum dots in terms of the ratio of nonvolatile components. Then, 2 parts by mass of a thermal acid generator TA-100 (available from San-Apro Ltd.) and 20 parts by mass of a cross-linking agent THI-DE were weighed and mixed per 100 parts by mass of the nonvolatile component of the silicone resin. After mixing, the toluene solvent was removed by vacuum distillation to obtain a quantum dot-containing composition.

### (Method for Producing a Wavelength Conversion Member)

A wavelength conversion member was fabricated using the obtained quantum dot-containing composition. The quantum dot-containing composition was vacuum degassed and, after adjusting its solid content concentration to 20%, poured into a fluororesin-coated, 20 cm×10 cm, 500 μm thick mold. The composition was then heated on a hot plate at 120° C. for 1 hour to thermally cure the quantum dot-containing composition while volatilizing the solvent. The composition was then removed from the mold. Thus, a 100 μm thick wavelength conversion member was fabricated.

### Comparative Example 3

The same steps as those in Example 1 were followed up to the quantum dot shell layer synthesis step, and a wavelength conversion member was fabricated in the same manner as in Example 3 without the ligand exchange step and the surface coating layer formation step.

### Example 4

The same steps as those in Example 1 were followed up to the ligand exchange step.

### (Surface Coating Layer Formation Step)

To a nitrogen-purged flask were added triethoxysilylpropyl methacrylate (4.0 mmol), diphenylsilanediol (6.0 mmol), barium hydroxide monohydrate (0.15 mmol), and the quantum dot toluene solution after the ligand exchange step, followed by heating with stirring at 65° C. for 24 hours. After completion of the reaction, the solution was cooled to room temperature, and ethanol was added to precipitate the reaction solution, which was then centrifuged to remove the supernatant. The solution was then dispersed in toluene and added to a nitrogen-purged flask. Then, 2 parts by mass of a phenol-reactive compound with a fluorene skeleton, BIOAP-FL (available from Asahi Yukizai Corporation) was added per 100 parts by mass of the quantum dot toluene solution. Further, 1 part by mass of Irgacure 1173 was added per 100 parts by mass of BIOAP-FL. After stirring and mixing, the solution was irradiated with light from a UV-LED irradiation device (wavelength: 365 nm, output: 4000 mW/cm²) for 20 seconds. After completion of the reaction, ethanol was added to precipitate the solution, which was then centrifuged to remove the supernatant. The solution was then dispersed in toluene again.

### (Resin Composition Mixing Step)

Phenolic cross-linkable silicone resin (CAS No. 916059-41-1; available from Shin-Etsu Chemical Co., Ltd.) and the solution after the surface coating layer formation step, dispersed in toluene, were weighed and mixed to contain 20% by mass of quantum dots in terms of the ratio of nonvolatile components. Then, 2 parts by mass of a thermal acid generator TA-100 (available from San-Apro Ltd.) and 20 parts by mass of a cross-linking agent THI-DE were weighed and mixed per 100 parts by mass of the nonvolatile component of the silicone resin. After mixing, the toluene solvent was removed by vacuum distillation to obtain a quantum dot-containing composition.

### (Method for Producing a Wavelength Conversion Member)

A wavelength conversion member was fabricated using the obtained quantum dot-containing composition. The quantum dot-containing composition was vacuum degassed and, after adjusting its solid content concentration to 20%, poured into a fluororesin-coated, 20 cm×10 cm, 500 μm thick mold. The composition was then heated on a hot plate at 120° C. for 1 hour to thermally cure the quantum dot-containing composition while volatilizing the solvent. The composition was then removed from the mold. Thus, a 100 μm thick wavelength conversion member was fabricated.

### Comparative Example 4

The same steps as those in Example 1 were followed up to the quantum dot shell layer synthesis step, and a wavelength conversion member was fabricated in the same manner as in Example 4 without the ligand exchange step and the surface coating layer formation step.

The results of comparison between Examples 1 to 4 and Comparative Examples 1 to 4 are shown in Table 1.

TABLE 1

| | | | | | | Comp. | Comp. | Comp. | Comp. |
|---|---|---|---|---|---|---|---|---|---|
| | | Ex. 1 | Ex. 2 | Ex. 3 | Ex. 4 | Ex. 1 | Ex. 2 | Ex. 3 | Ex . 4 |
| After | Wavelength | 536 | Same | Same | Same | Same | Same | Same | Same |
| quantum dot | (nm) | | as | as | as | as | as | as | as |
| synthesis | | | left | left | left | left | left | left | left |
| | Half width | 41 | Same | Same | Same | Same | Same | Same | Same |
| | (nm) | | as | as | as | as | as | as | as |
| | | | left | left | left | left | left | left | left |
| | Internal | 60 | Same | Same | Same | Same | Same | Same | Same |
| | quantum | | as | as | as | as | as | as | as |
| | efficiency | | left | left | left | left | left | left | left |
| | (%) | | | | | | | | |
| After | Wavelength | 536 | Same | Same | Same | — | — | — | — |
| ligand | (nm) | | as | as | as | | | | |
| exchange | | | left | left | left | | | | |
| | Half width | 41 | Same | Same | Same | — | — | — | — |
| | (nm) | | as | as | as | | | | |
| | | | left | left | left | | | | |
| | Internal | 62 | Same | Same | Same | — | — | — | — |
| | quantum | | as | as | as | | | | |
| | efficiency | | left | left | left | | | | |
| | (%) | | | | | | | | |
| Quantum | Wavelength | 536 | 538 | 539 | 534 | — | — | — | — |
| dot- | (nm) | | | | | | | | |
| containing | Half width | 41 | 41 | 41 | 42 | — | — | — | — |
| composition | (nm) | | | | | | | | |
| | Internal | 60 | 61 | 59 | 62 | — | — | — | — |
| | quantum | | | | | | | | |
| | efficiency | | | | | | | | |
| | (%) | | | | | | | | |
| Wavelength | Wavelength | 536 | 538 | 539 | 534 | 536 | 544 | 542 | 544 |
| conversion | (nm) | | | | | | | | |
| member | Half width | 41 | 42 | 42 | 42 | 51 | 48 | 48 | 44 |
| | (nm) | | | | | | | | |
| | Internal | 54 | 49 | 45 | 50 | 20 | 24 | 16 | 18 |
| | quantum | | | | | | | | |
| | efficiency | | | | | | | | |
| | (%) | | | | | | | | |
| Change in | Decrease | 3 | 5 | 10 | 8 | 51 | 47 | 82 | 90 |
| quantum | rate (%) | | | | | | | | |
| yield after | | | | | | | | | |
| reliability | | | | | | | | | |
| test | | | | | | | | | |

| | | | | | | | | |
|---|---|---|---|---|---|---|---|---|
| Microscopic | Few | Few | Few | Few | Many | Many | Many | Many |
| observations after | | | | | | | | |
| curing resin | | | | | | | | |
| composition | | | | | | | | |
| Presence of aggregates | | | | | | | | |
| (sized 1 μm or | | | | | | | | |
| greater) | | | | | | | | |

The table shows the values of the fluorescence emission efficiency after curing of the resin composition and the fluorescence emission efficiency after the reliability evaluation. From the results in Table 1, it can be seen that Comparative Examples have a lower quantum yield than Examples and also have a greater shift to a longer emission wavelength. Microscopic observations revealed that many aggregates around 1 to 50 μm were observed in Comparative Examples 1 to 4, which led to the lower quantum yield. On the other hand, there were smaller and fewer aggregates in Examples, which is believed to have suppressed the decrease in quantum yield. Examples show that aggregation can be effectively suppressed by the introduction of a significant steric hindrance through the coating with silicone or resin. Comparison between the results of the reliability test (85° C., 85% RH, 250 hours of treatment) shows that Examples have improved stability over Comparative Examples, suppressing the decrease in quantum yield.

Thus, it was confirmed that the inventive quantum dot-containing composition exhibits high stability and that the wavelength conversion member made therefrom suppresses the degradation of fluorescence emission efficiency under high-temperature and high-humidity conditions and provides high reliability.

The present description includes the following embodiments.
[1]: A quantum dot-containing composition comprising:
quantum dots dispersed in a resin composition, the quantum dots emitting fluorescence by excitation light, wherein
the quantum dots include a ligand coordinated to a surface thereof and a surface coating layer bonded to the ligand and containing a siloxane bond, and
the surface coating layer contains at least one of substituents of a polymer contained in the resin composition, substituents polymerizable with a polymer contained in the resin composition, and compounds having a same skeleton structure as the polymer.
[2]: The quantum dot-containing composition of the above [1], wherein the quantum dots contain a quantum dot core selected from the group consisting of II-VI, III-V, IV, IV-VI, I-III-VI and II-IV-V groups, mixed crystals and alloys thereof, and compounds having a perovskite structure.
[3]: The quantum dot-containing composition of the above [2], wherein the quantum dots contain a core-shell quantum dot having the quantum dot core coated with a shell with a larger band gap than the quantum dot core.
[4]: The quantum dot-containing composition of the above [1], [2], or [3], wherein the ligand includes one or more of an amino group, a thiol group, a carboxy group, a phosphino group, a phosphine oxide group, and an ammonium ion.
[5]: The quantum dot-containing composition of the above [1], [2], [3], or [4], wherein the substituents of a polymer contained in the resin composition are one or more of a vinyl group, an acrylic group, a methacrylic group, a hydroxy group, a phenolic hydroxy group, and an epoxy group.
[6]: The quantum dot-containing composition of the above [1], [2], [3], [4], or [5], wherein the substituents polymerizable with a polymer contained in the resin composition are one or more of a vinyl group, an acrylic group, a methacrylic group, a hydroxy group, a phenolic hydroxy group, and an epoxy group.
[7]: The quantum dot-containing composition of the above [1], [2], [3], [4], [5], or [6], wherein the same skeleton structure as the polymer is a skeleton structure derived from acrylic acid, methacrylic acid, acrylic acid esters or methacrylic acid esters, a silphenylene skeleton, a norbornene skeleton, a fluorene skeleton, or an isocyanurate skeleton.
[8]: A wavelength conversion member comprising a cured product of the quantum dot-containing composition of the above [1], [2], [3], [4], [5], [6], or [7].
[9]: A method for producing the quantum dot-containing composition of the above [1], [2], [3], [4], [5], [6], or [7] containing quantum dots that emit fluorescence by excitation light, the method comprising:
a ligand exchange step of mixing a solution in which the quantum dots are dispersed with a ligand having a siloxane bond-forming substituent to thereby coordinate the ligand to an outermost surface of the quantum dots;
a surface coating layer formation step of initiating, after the ligand exchange step, a reaction between the siloxane bond-forming substituent and a compound that reacts with the siloxane bond-forming substituent to generate polysiloxane, to thereby form a surface coating layer; and
a resin composition mixing step of mixing, after the surface coating layer formation step, the quantum dots coated with the surface coating layer with the resin composition.

It should be noted that the present invention is not limited to the above-described embodiments. The embodiments are just examples, and any examples that substantially have the same feature and demonstrate the same functions and effects as those in the technical concept disclosed in claims of the present invention are included in the technical scope of the present invention.

1-9. (canceled)

10. A quantum dot-containing composition comprising:
quantum dots dispersed in a resin composition, the quantum dots emitting fluorescence by excitation light, wherein
the quantum dots include a ligand coordinated to a surface thereof and a surface coating layer bonded to the ligand and containing a siloxane bond, and
the surface coating layer contains at least one of substituents of a polymer contained in the resin composition, substituents polymerizable with a polymer contained in the resin composition, and compounds having a same skeleton structure as the polymer.

11. The quantum dot-containing composition according to claim 10, wherein the quantum dots contain a quantum dot core selected from the group consisting of II-VI, III-V, IV, IV-VI, I-III-VI and II-IV-V groups, mixed crystals and alloys thereof, and compounds having a perovskite structure.

12. The quantum dot-containing composition according to claim 11, wherein the quantum dots contain a core-shell quantum dot having the quantum dot core coated with a shell with a larger band gap than the quantum dot core.

13. The quantum dot-containing composition according to claim 10, wherein the ligand includes one or more of an amino group, a thiol group, a carboxy group, a phosphino group, a phosphine oxide group, and an ammonium ion.

14. The quantum dot-containing composition according to claim 10, wherein the substituents of a polymer contained in the resin composition are one or more of a vinyl group, an acrylic group, a methacrylic group, a hydroxy group, a phenolic hydroxy group, and an epoxy group.

15. The quantum dot-containing composition according to claim 10, wherein the substituents polymerizable with a polymer contained in the resin composition are one or more of a vinyl group, an acrylic group, a methacrylic group, a hydroxy group, a phenolic hydroxy group, and an epoxy group.

16. The quantum dot-containing composition according to claim 10, wherein the same skeleton structure as the polymer is a skeleton structure derived from acrylic acid, methacrylic acid, acrylic acid esters or methacrylic acid esters, a silphenylene skeleton, a norbornene skeleton, a fluorene skeleton, or an isocyanurate skeleton.

17. A wavelength conversion member comprising a cured product of the quantum dot-containing composition according to claim 10.

18. A wavelength conversion member comprising a cured product of the quantum dot-containing composition according to claim 11.

19. A wavelength conversion member comprising a cured product of the quantum dot-containing composition according to claim 12.

20. A wavelength conversion member comprising a cured product of the quantum dot-containing composition according to claim 13.

21. A wavelength conversion member comprising a cured product of the quantum dot-containing composition according to claim 14.

22. A wavelength conversion member comprising a cured product of the quantum dot-containing composition according to claim 15.

23. A wavelength conversion member comprising a cured product of the quantum dot-containing composition according to claim 16.

24. A method for producing the quantum dot-containing composition according to claim 10 containing quantum dots that emit fluorescence by excitation light, the method comprising:
a ligand exchange step of mixing a solution in which the quantum dots are dispersed with a ligand having a siloxane bond-forming substituent to thereby coordinate the ligand to an outermost surface of the quantum dots;
a surface coating layer formation step of initiating, after the ligand exchange step, a reaction between the siloxane bond-forming substituent and a compound that reacts with the siloxane bond-forming substituent to generate polysiloxane, to thereby form a surface coating layer; and
a resin composition mixing step of mixing, after the surface coating layer formation step, the quantum dots coated with the surface coating layer with the resin composition.
